(19) United States
(12) Patent Application Publication
(10) Pub. No.: US 2020/0016611 A1
(43) Pub. Date: Jan. 16, 2020

(54) CENTRIFUGAL SOLIDS SEPARATOR

(71) Applicant: FHE USA LLC, Fruita, CO (US)

(72) Inventors: Matthew Kibler, Grand Junction, CO (US); Kyle Scholl, Dunlap, IL (US); Nicolas G. Snoke, Grand Junction, CO (US); Keith C. Johansen, Fruita, CO (US)

(21) Appl. No.: 16/149,752

(22) Filed: Oct. 2, 2018

Related U.S. Application Data
(60) Provisional application No. 62/698,373, filed on Jul. 16, 2018.

(51) Int. Cl. B04C 5/04; E21B 41/00; B04C 5/085; B04C 5/103; B01D 21/26; B04C 11/00; B01D 21/32

(52) U.S. Cl. CPC B04C 5/04; E21B 41/00; B04C 5/085; E21B 43/267; B01D 21/267; B04C 11/00; B01D 21/32; B04C 5/103

(57) ABSTRACT

A solids separator includes a housing having a fluid inlet, the fluid inlet oriented to induce helical flow of fluid entering the housing. A flow reversing device is disposed within the housing and is arranged to reverse a longitudinal direction of the helical flow within the housing. A fluid outlet is disposed at an upper end of the housing. The fluid outlet includes within its cross-section a radial center of the housing.

### CROSS REFERENCE TO RELATED APPLICATIONS

Priority is claimed from U.S. Provisional Application No. 62/698,373 filed Jul. 16, 2018. The foregoing application is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of separators used to extract solid particles from liquid. More specifically, the disclosure relates to separators that can be used to extract proppant from hydraulic fracturing fluid recovered from subsurface wells.

The present disclosure will be explained in terms of fluids produced from a subsurface well after pumping a hydraulic fracturing treatment or treatments. It is to be understood that the scope of uses of a separator according to the present disclosure is not limited to being used on such fluids or wells.

Wells drilled through certain subsurface formations may have productivity increased by treating the subsurface formations through which the wells are drilled. Such treatment includes hydraulic fracturing, in which fluid is pumped into the formations under pressure sufficient to crack or fracture the formations. The cracks or fractures may be supported to remain open after relief of the fluid pressure by pumping, with the treatment fluid, solid particles collectively called “proppant”, which particles enter the cracks and hold them open after relief of the fluid pressure. After the treatment is pumped, the well may be placed “on production”, wherein fluid is moved from the subsurface formations through the well to the surface. Frequently, proppant particles, which may include sand or similar particulate material, are moved to the surface with the moved fluid. It is desirable to extract as much of the proppant as practical from the produced fluid. Devices are known in the art, such as screens, filers or other particle size dependent separators for extracting the solid particles (“solids”) from the produced fluid. It is desirable to have devices for separating solids that are more efficient than devices known in the art.

### SUMMARY

A solids separator according to one aspect of the disclosure includes a housing having a fluid inlet, the fluid inlet oriented to induce helical flow of fluid entering the housing. A flow reversing device is disposed within the housing and is arranged to reverse a longitudinal direction of the helical flow within the housing. A fluid outlet is disposed at an upper end of the housing. The fluid outlet includes within its cross-section a radial center of the housing.

In some embodiments, the fluid inlet is disposed within a removable cap attached to one longitudinal end of the housing.

In some embodiments the fluid inlet comprises a nozzle shaped to change a velocity of fluid entering the housing.

In some embodiments the nozzle is replaceable.

Some embodiments further comprise a swirl director disposed in a fluid flow path between the fluid inlet and the housing, the swirl director shaped to induce a longitudinal component of motion to fluid entering the housing.

In some embodiments the swirl director is replaceable.

Some embodiments further comprise a wear sleeve disposed in the housing proximate to the fluid inlet and extending a selected longitudinal distance along an interior of the housing.

Some embodiments further comprise a baffle disposed in an interior of the housing, the baffle including within its cross-section a radial center of the housing, the baffle having a flow outlet in fluid communication with the fluid outlet.

In some embodiments the baffle comprises a canister defining an exterior of the baffle, the canister defining an annular space within the housing to constrain flow of fluid within the housing.

In some embodiments, the canister comprises a tapered exterior.

In some embodiments the baffle further comprises vanes disposed within the canister to impart rotational motion to incoming fluid.

Some embodiments further comprise a deflector coupled to a lower end of the baffle.

In some embodiments, the flow reversing device comprises a deflector disposed in the housing, the deflector shaped to urge solids in flowing fluid radially outward toward a wall of the housing and to reverse the longitudinal direction of flow of fluid having solids extracted therefrom.

Some embodiments further comprise a fluid return tube disposed in the housing and extending to one longitudinal end of the housing proximate the fluid outlet, the fluid return tube shaped to define an annular space within the housing between an interior wall of the housing and an exterior of the fluid return tube, the separator further comprising a recirculation tube nested between the housing and the fluid return tube and extending to the one longitudinal end of the housing, the recirculation tube configured to reverse the longitudinal direction of fluid flow from the fluid return tube.

Some embodiments further comprise a sleeve nested between the recirculation tube and the housing, the sleeve configured to receive fluid from the fluid inlet.

Some embodiments further comprise a valve disposed at a bottom end of the housing to enable selective discharge of solids from the housing.

In some embodiments the valve is remotely operable.

Some embodiments further comprise a solids level sensor arranged to measure an amount of separated solids within the housing. For example, the sensor may be disposed in or on the housing.

Some embodiments further comprise at least one of: a display in signal communication with the solids level sensor; and an automatically controllable valve disposed at a bottom end of the housing and in signal communication with the solids level sensor to enable automatic discharge of solids from the housing when the amount of separated solids reaches a predetermined value.

Some embodiments further comprise a fluid inlet solids fraction sensor proximate the fluid inlet, a liquid outlet solids fraction sensor in fluid communication with the fluid outlet and a processor in signal communication with the fluid inlet solids fraction sensor and the liquid outlet solids fraction sensor, the processor configured to calculate a fraction of solids in fluid at the fluid inlet removed by the separator and to generate a signal corresponding to the fraction of solids removed.

Other aspects and possible advantages will be apparent from the description and claims which follow.

### BRIEF DESCRIPTION OF THE DRAWINGS

FIG. 1 shows an exploded view of an example embodiment of a separator according to the present disclosure.

FIG. 2 shows part of the exploded view of FIG. 1 in more detail.

FIG. 3 shows some components of the view in FIG. 1 in more detail.

FIG. 4 shows a cut away view of the upper portion of the separator shown in FIG. 1.

FIG. 5 shows a sectioned view of the separator upper portion shown in FIG. 4

FIG. 6 shows an example embodiment of a baffle.

FIG. 7 shows another example embodiment of a baffle.

FIG. 8 shows another example embodiment of a baffle.

FIG. 9 shows another view of the example embodiment of the baffle shown in

FIG. 8.

FIG. 10 shows an example embodiment of a baffle similar to that of FIG. 5.

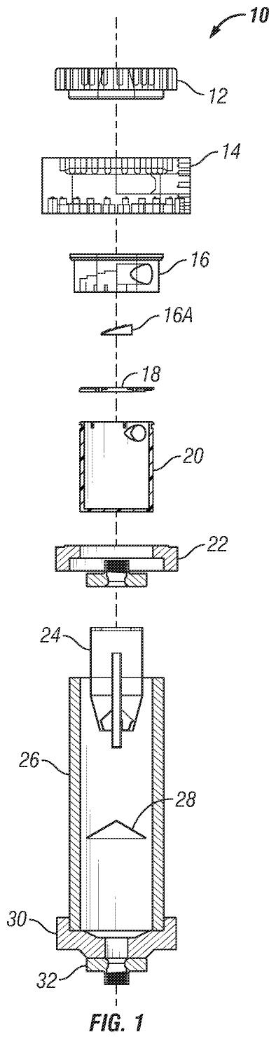

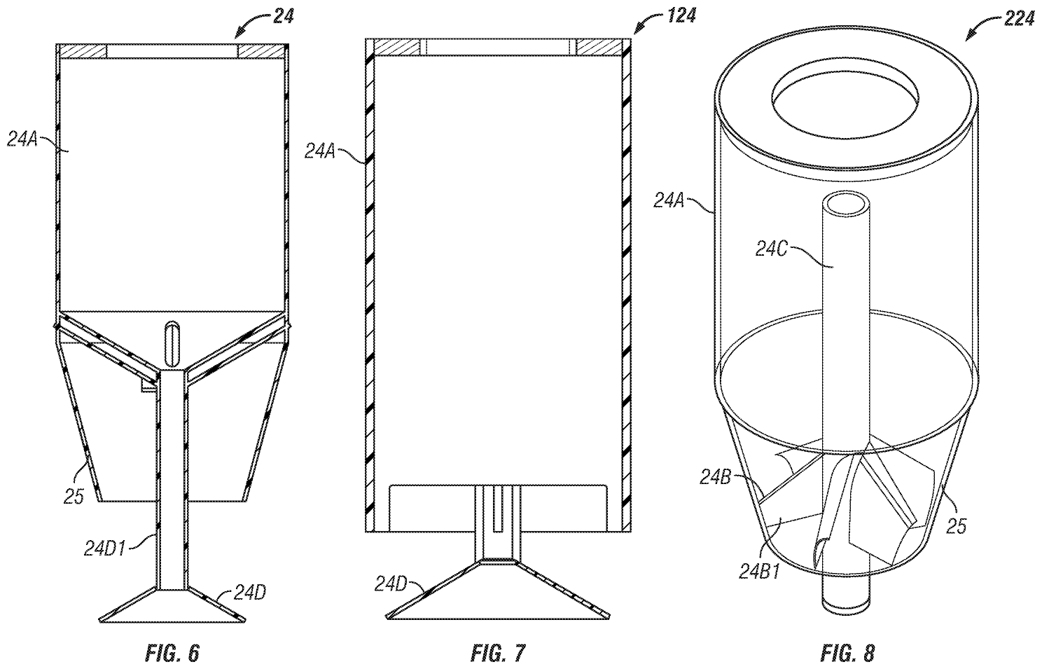

FIG. 11 shows the example embodiment of the baffle of FIG. 6 disposed in the separator as shown in FIG. 1.

FIG. 12 shows a baffle and a deflector in a separator as shown in FIG. 1.

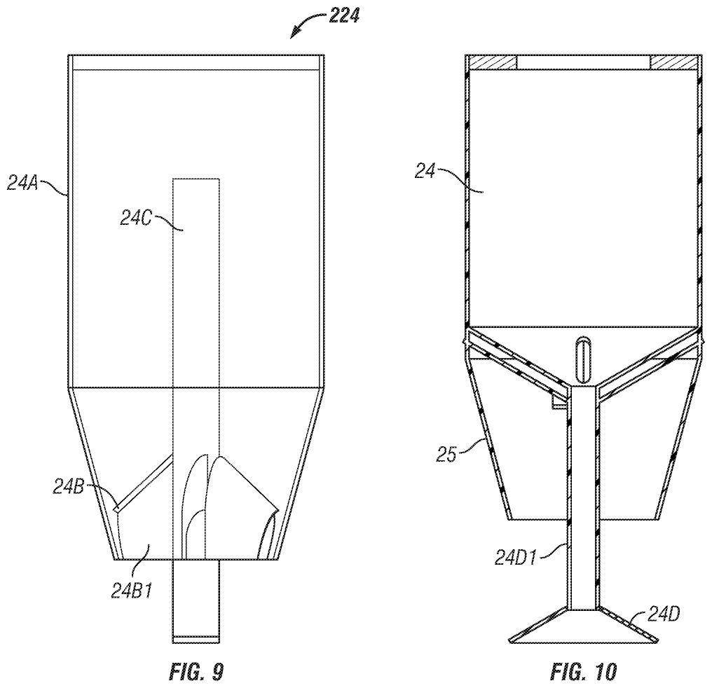

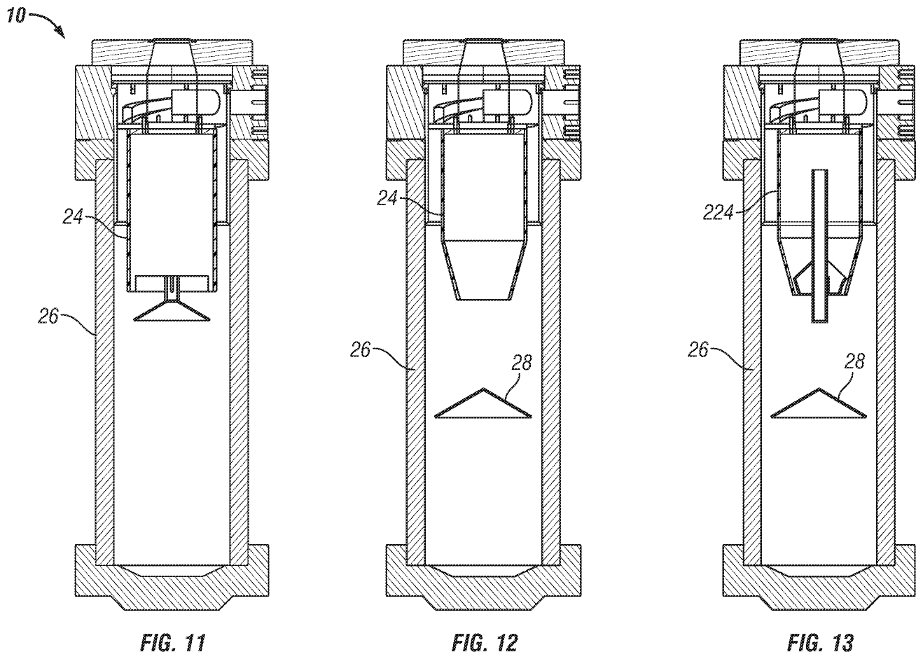

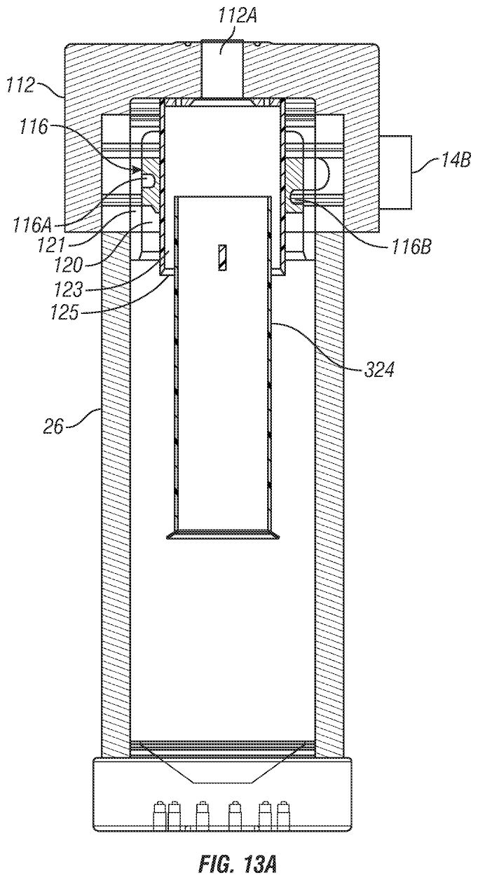

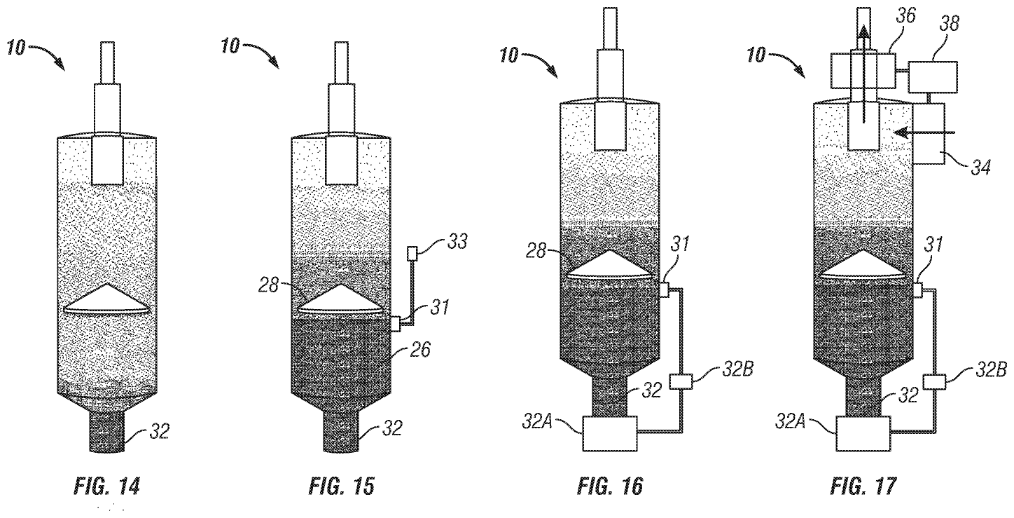

FIG. 13 shows a baffle as in FIG. 9 and a deflector in a separator as shown in

FIG. 1.

FIG. 13A shows another embodiment of a separator according to the present disclosure.

FIG. 14 shows an example embodiment of an unistrumented separator.

FIG. 15 shows a separator as in FIG. 14 including a solids level sensor and indicator.

FIG. 16 shows the separator of FIG. 15 including an automated solids dump valve.

FIG. 17 shows the embodiment of separator of FIG. 16 including sensors for measuring fluid inlet and fluid outlet solids content sensors.

### DETAILED DESCRIPTION

FIG. 1 shows an exploded view of an example embodiment of a solids separator (“separator”) according to the present disclosure. The separator 10 may comprise a fluid inlet 14 that may be connected to a source of fluid from which solids are to be separated, for example, a flow line from a subsurface well from which fluid such as water and/or hydrocarbons are produced. The fluid inlet 14 may comprise a nozzle (14A in FIG. 3) that directs incoming fluid flow tangentially toward the perimeter of the fluid inlet 14 and may increase the fluid velocity as it enters the separator 10, thereby imparting rotational motion to the incoming fluid. The fluid inlet 14 may have an integral or separate cover 12 affixed thereto above the fluid inlet 14. The fluid inlet 14 may comprise an integrally formed or removable, replaceable flow or swirl director 16. The swirl director 16 may be affixed to a lower side of the fluid inlet 14 and may comprise an insert 16A or similar device to impart a longitudinal (with respect to the separator 10) component to motion of the incoming fluid. The longitudinal component of motion, if imparted, is superimposed on the rotational flow imparted by the fluid inlet 14 such that the fluid motion inside the separator 10 becomes helical.

A baffle adapter 18 may be used to secure a baffle 24, embodiments of which will be further explained below, inside a shell or housing 26. The housing 26 may be substantially cylindrical to facilitate helical flow within the housing 26. An abrasion or wear sleeve 20, which may be made from a material resistant to abrasive wear such as tungsten carbide, other metal carbide or any similar hard material, may be disposed in the upper end of the housing 26 and retained in longitudinal position within the housing 26 and the fluid inlet 14 by an adapter flange 22 coupled to the upper end of the housing 26. In some embodiments, the abrasion sleeve 20 may be replaceable, for example by removing the fluid inlet 14 and adapter flange 22 to enable removal of the abrasion sleeve 20.

A longitudinal flow reversing device such as a deflector 28 may be disposed at a selected longitudinal position within the housing 26, in general below the bottom of the baffle 24, wherein solids that are urged radially outwardly as a result of helical motion of the fluid within the fluid inlet 14 and the housing 26, may be further urged radially outwardly. By way of the deflector 18, liquid may be urged radially inwardly and have the longitudinal component of its motion reversed. Such imparted liquid motion may enable separated liquid to move upwardly within the separator 10 and further upwardly through an opening (12A in FIG. 3) such as a discharge port or fluid outlet in the separator cover 12. In embodiments such as shown in FIG. 1, separated liquid may discharge through the upper end or top of the separator 10. The baffle 24 and the opening (12A in FIG. 3) may be disposed within the housing 26 to include within their respective cross-sections a radial center of the housing 26.

The lower longitudinal end of the housing 26 may comprise an end cap such as a lower adapter 30. If used, the lower adapter 30 may enable coupling of a solids outlet 32, wherein an interior shape of the lower adapter 30 may be such that discharge of separated solids is facilitated by gravity from within the housing 26 when a port or valve 32 (see FIGS. 14 through 17) is opened.

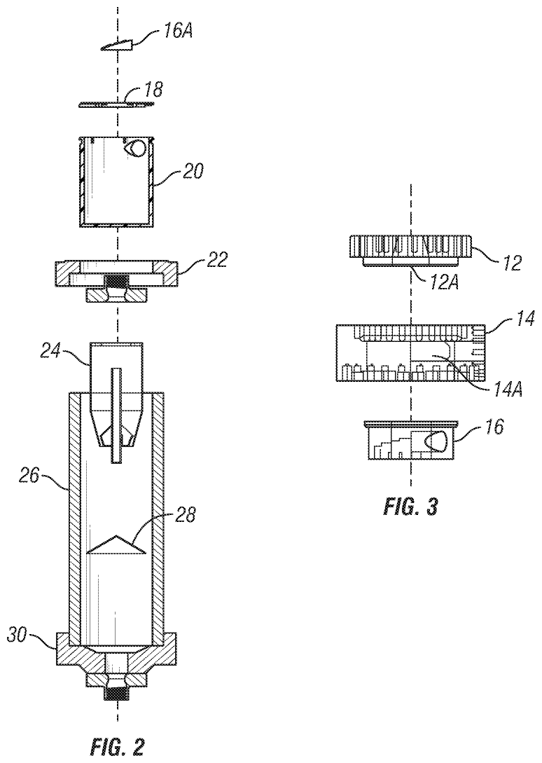

FIG. 2 shows the swirl director insert 16A, baffle adapter 18, adapter flange 22, baffle 24, housing 26, deflector 28, and lower adapter 30 in more detail. In some embodiments, such as one shown in and explained with reference to FIG. 13A, the separator cover (see 112 in FIG. 13A) may be integrally formed with the fluid inlet 14, nozzle 14A, swirl director 16, and swirl director insert 16A as shown in FIGS. 1 and 2.

FIG. 3 shows the separator cover 12 and opening 12A, fluid inlet 14 and muzzle 14A, and swirl director 16 in more detail.

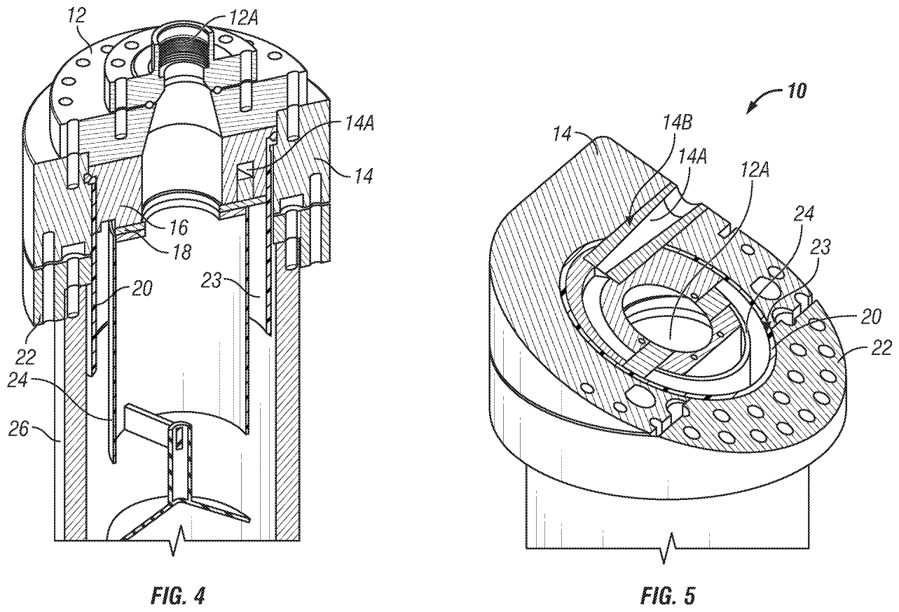

A cut away view of an assembled version of the example embodiment of the separator 10 shown in FIG. 1 is shown in FIG. 4, other than the lower adapter (30 in FIG. 1) and dump valve (32 in FIG. 1) so that arrangement of the components as assembled and how they are retained in place in the assembled separator 10 may be better understood.

FIG. 5 shows an oblique cut away view of some of the components shown in FIG. 4 to better illustrate their function in the separator 10. FIG. 5 shows the nozzle 14A as it is disposed in an inlet port 14B in the fluid inlet 14. The nozzle 14A may be removable in some embodiments to facilitate replacement without requiring replacement of the fluid inlet 14. Arrangement of the nozzle 14A to direct incoming fluid flow tangentially toward the abrasion sleeve 20 is clearly observable in FIG. 5. The opening 12A, baffle 24 and adapter flange 22 may also be observed in their assembled relationship.

Various embodiments of the baffle (24 in FIG. 1) will now be explained with reference to FIGS. 6 through 9. A first embodiment of the baffle is shown at 24 in FIG. 6. The baffle 24 may comprise a canister 24A, which may be generally cylindrically shaped and have an external diameter such that downwardly helically moving fluid in the housing (26 in FIG. 1) may be constrained to flow in an annular space (see 23 in FIGS. 4 and 5) between the canister 24A and the interior wall of the housing (26 in FIG. 1). In the embodiment shown in FIG. 6, the canister 24A may comprise a tapered exterior 25 along the lower part of the canister 24A shaped to increase the size of the annular space with respect to longitudinal position. Such size relationship of the annular space may facilitate reducing velocity of the fluid flowing in the annular space (23 in FIGS. 4 and 5). A deflector 24D may be disposed at a selected longitudinal position below the bottom of the canister 24A, for example, by being coupled to the canister 24A by any suitable mounting arrangement such as shown at 24D1 in FIG. 6. The deflector 24D may serve to urge solids toward the wall of the housing (26 in FIG. 1) while reversing longitudinal motion of separated liquid toward the top of the separator (e.g., through opening 12A in FIG. 4). FIG. 7 shows another embodiment of the baffle 124 in which the tapered exterior surface (25 in FIG. 6) is omitted.

FIGS. 8 and 9 show another embodiment of the baffle 224 in which a canister 24A may be formed substantially as explained with reference to FIG. 6 or FIG. 7. In such embodiments as will be further explained below, the deflector may be mounted within the housing (26 in FIG. 1) separately from the baffle 224, for example, as shown at 28 in FIG. 1. In the embodiment shown in FIGS. 8 and 9, a set of vanes 24B may be disposed in the liquid inlet 24B1 of the baffle 224. The set of vanes 24B may be axially offset from parallel to the axis of the housing (26 in FIG. 4) to impart a rotational component to the upward motion of liquid into the baffle 224. Such rotational motion may enable further removal of any entrained solids within the upwardly flowing liquid. The set of vanes 24B may be supported on a support tube 24C, which may extend a selected longitudinal distance above and below the set of vanes 24B to provide a minimum internal diameter to the flow pattern of entering liquid.

FIGS. 10 through 13 show various example embodiments of the baffle 24 and deflector (28 in FIGS. 12 and 13 when the baffle is mounted separately to the interior of the housing 26) as may be used with a separator according to the present disclosure. The embodiment of the baffle 24D shown in FIG. 10 may be mounted within the housing 26 by affixing the baffle 24D to a support tube 24D1 as explained with reference to FIGS. 8 and 9. The embodiment in FIG. 10 may comprise the tapered exterior surface 25. FIG. 11 shows the embodiment of the baffle substantially as shown in FIG. 7 wherein the tapered exterior surface (25 in FIG. 10) is omitted, and as the baffle 24 may be mounted within the housing 26. Because the deflector 24D is part of the baffle 24 in FIG. 11, it is not necessary to provide a separate deflector in such embodiment.

FIG. 12 shows an embodiment of the baffle 24 similar to the embodiment shown in FIG. 10, but with a deflector not being structurally connected to the baffle 24. The baffle as in FIG. 12 may be mounted within the housing 26 substantially as explained above with reference to FIG. 3. Because the embodiment of the baffle 24 shown in FIG. 12 does not include a connected deflector, a separate deflector 28 may be mounted to the interior of the housing 26 at a selected position below the bottom of the baffle 24. FIG. 13 shows an embodiment of the baffle 224, substantially explained with reference to FIGS. 8 and 9, mounted within the housing 26; wherein the deflector 28 is mounted to the interior of the housing 26 rather than to the baffle 224.

FIG. 13A shows another embodiment of a separator according to the present disclosure. A cap 112 may be configured as explained with reference to FIG. 1 and FIG. 3, or the cap 112 may be a single component, integrally comprising the various components shown in and explained with reference to FIG. 1 and FIG. 3. A housing 26 may be configured as explained with reference to other embodiments described above, including without limitation FIGS. 1, 2 and 3. A first swirl director passage cross-section 116A and second swirl director passage cross-section 116B are shown to illustrate the flow path traversed by fluid after it enters the fluid inlet 14B. The cap 112 as explained above with reference to FIGS. 1 and 2 may be integrally formed to include the fluid inlet 14B, a fluid outlet 112A and the swirl director 116. The swirl director 116 may induce helical motion to fluid entering through the fluid inlet 14B as explained with reference to FIGS. 1 through 3.

Fluid leaving the swirl director 116 may enter an annulus 120 defined by a sleeve 121. The sleeve 121 may be made from or include an internal coating on its surface of wear resistant material such as tungsten carbide or other metal carbide. Helical fluid flow within the annulus 120 may urge solids entrained in the fluid flow to impact the sleeve 121 so as to lose velocity and tend to drop within the housing 26 by gravity. Longitudinal direction of the fluid flow may be reversed, such as by impacting the bottom of the housing 26, and any accumulated solids on the bottom of the housing 26. Longitudinally reversed fluid flow may enter a return tube 324. Some embodiments may include a deflector (not shown in FIG. 13A) as explained with reference to FIGS. 1 and 6 through 13. When the reversed flow fluid reaches the top of the return tube 324, the longitudinal direction of fluid flow may be reversed once again by suitable placement of a recirculation tube 125 externally to the return tube 324 to form a recirculation annulus 123 wherein still entrained solids may be urged against the wall of the recirculation tube 125. Liquid leaving the recirculation annulus 123 will have its longitudinal flow direction reversed in the housing 26 so as to reenter the return tube 324 and eventually discharge through the fluid outlet 112A.

FIGS. 14 through 16 show various embodiments of an instrumented and/or automatically operated separator. FIG. 14 shows an embodiment of the separator 10 which may be configured substantially as explained with reference to FIG. 1 (components), FIG. 4 (flow components) and FIG. 13 (baffle with separate deflector). Other combinations of components as explained herein to form various embodiments of the separator 10. In the embodiment of FIG. 13A, there is no instrumentation. Observations or experience with using the separator 10 by its operator may determine when the dump valve 32 may need to be opened to discharge accumulated solids from the housing (see 26 in FIG. 1). In FIG. 15, a solids level sensor 31 may be, for example and without limitation, an acoustic sensor, a temperature sensor, a capacitance sensor and/or a weight sensor (if the housing is mounted such that its weight can be measured). Signals from the solids level sensor 31 may be communicated to a level indicator 33 of any type known in the art capable of generating an indication to the user or operator that the solids level in the housing (26 in FIG. 1) and that it is therefore advisable to operate the dump valve 32. As an example, the level indicator may provide indication of the need to operate the dump valve 32 when the solids level is within a selected elevation of the deflector 28. The indication made by the level indicator 33 may be “go/no-go”, that is, generates a signal indicative of a threshold level of solids being present, or may be a proportional gauge showing a signal or indication related to the elevation of solids in the housing 26.

FIG. 16 shows another implementation wherein operation of the dump valve may be automated. In FIG. 16, the solids level sensor 33 may be in signal communication with a dump valve operator 32B. The dump valve operator 32B, on detection of a suitable signal from the solids level sensor 33, communicate an operating signal to a power operated dump valve 32A. The dump valve operator 32B may be logic encoded into a processor, programmable logic controller or other digital controller, or may be as simple as and electric, hydraulic or pneumatic relay. Thus, the power operated dump valve 32B may operate without user intervention to keep the housing 26 from overfilling with separated solids.

In FIG. 17, the separator 10 may include a fluid inlet solids fraction sensor 34 and a liquid outlet solids fraction sensor 36. The foregoing sensors 34, 36 may be any type of sensor whose signal can be used to estimate or determine solids fraction of the fluid flowing through the respective sensor. Non-limiting examples of such sensor may include capacitance sensors, density sensor and optical transparency sensors. During operation of the separator 10, signals from the fluid inlet solid fraction sensor 34 may be compared to signals from the liquid outlet solid fraction sensor 36, e.g., by a processor 38 to provide an indication of the fraction of solids entering the separator 10 that are extracted by the separator. Indications of a reduction in the removed solids fraction may be used to determine, e.g., when servicing of one or more components of the separator is required. The processor 38 may be configured to generate a signal, for example a numerical or other indicator to drive a display wherein the user may observe changes in the fraction of solids removed by the separator. The processor may in addition or in the alternative operate an alarm or other signaling device when the solids extraction fraction drops below a selected threshold.

Although the various aspects of the present disclosure have been described above, in part, with reference to particular examples, those skilled in the art will readily appreciate that many modifications are possible in the examples. Accordingly, all such modifications are intended to be included within the scope of this disclosure as defined in the following claims.

What is claimed is:

1. A solids separator comprising:
a housing having a fluid inlet, the fluid inlet oriented to induce helical flow of fluid entering the housing;
a flow reversing device disposed within the housing and arranged to reverse a longitudinal direction of the helical flow within the housing; and
a fluid outlet at an upper end of the housing, the fluid outlet including within a cross-section thereof a radial center of the housing.

2. The separator of claim 1 wherein the fluid inlet is disposed within a removable cap attached to one longitudinal end of the housing.

3. The separator of claim 1 wherein the fluid inlet comprises a nozzle shaped to increase a velocity of fluid entering the housing.

4. The separator of claim 3 wherein the nozzle is replaceable.

5. The separator of claim 1 further comprising a swirl director disposed in a fluid flow path between the fluid inlet and the housing, the swirl director shaped to induce a longitudinal component of motion to fluid entering the housing.

6. The separator of claim 6 wherein the swirl director is replaceable.

7. The separator of claim 1 further comprising a wear sleeve disposed in the housing proximate to the fluid inlet and extending a selected longitudinal distance along an interior of the housing.

8. The separator of claim 1 further comprising a baffle disposed in an interior of the housing, the baffle including within its cross-section a radial center of the housing, the baffle having a flow outlet in fluid communication with the fluid outlet.

9. The separator of claim 8 wherein the baffle comprises a canister defining an exterior of the baffle, the canister defining an annular space within the housing to constrain flow of fluid within the housing.

10. The separator of claim 9 wherein the canister comprises a tapered exterior.

11. The separator of claim 9 wherein the baffle further comprises vanes disposed within the canister to impart rotational motion to incoming fluid.

12. The separator of claim 9 further comprising a deflector coupled to a lower end of the baffle.

13. The separator of claim 1 wherein the flow reversing device comprises a deflector disposed in the housing, the deflector shaped to urge solids in flowing fluid radially outward toward a wall of the housing and to reverse the longitudinal direction of flow of fluid having solids extracted therefrom.

14. The separator of claim 1 further comprising a fluid return tube disposed in the housing and extending to one longitudinal end of the housing proximate the fluid outlet, the fluid return tube shaped to define an annular space within the housing between an interior wall of the housing and an exterior of the fluid return tube, the separator further comprising a recirculation tube nested between the housing and the fluid return tube and extending to the one longitudinal end of the housing, the recirculation tube configured to reverse the longitudinal direction of fluid flow from the fluid return tube.

15. The separator of claim 14 further comprising a sleeve nested between the recirculation tube and the housing, the sleeve configured to receive fluid from the fluid inlet.

16. The separator of claim 1 further comprising a valve disposed at a bottom end of the housing to enable selective discharge of solids from the housing.

17. The separator of claim 16 wherein the valve is remotely operable.

18. The separator of claim 1 further comprising a solids level sensor disposed in or on the housing to measure an amount of separated solids within the housing.

19. The separator of claim 18 further comprising at least one of: a display in signal communication with the solids level sensor; and an automatically controllable valve disposed at a bottom end of the housing and in signal communication with the solids level sensor to enable automatic discharge of solids from the housing when the amount of separated solids reaches a predetermined value.

20. The separator of claim 1 further comprising a fluid inlet solids fraction sensor proximate the fluid inlet, a liquid outlet solids fraction sensor in fluid communication with the fluid outlet and a processor in signal communication with the fluid inlet solids fraction sensor and the liquid outlet solids fraction sensor, the processor configured to calculate a fraction of solids in fluid at the fluid inlet removed by the separator and to generate a signal corresponding to the fraction of solids removed.
